(19) United States
(12) Patent Application Publication
(10) Pub. No.: US 2019/0213168 A1
(43) Pub. Date: Jul. 11, 2019

(54) APPARATUS AND METHOD FOR PROTECTING A DIGITAL RIGHT OF MODEL DATA LEARNED FROM ARTIFICIAL INTELLIGENCE FOR SMART BROADCASTING CONTENTS

(71) Applicant: Markany Inc., Seoul (KR)

(72) Inventors: Chang Won Kim, Seoul (KR); Dong Hwan Shin, Seoul (KR); Hyun Gyu Kim, Seoul (KR); Jong Uk Choi, Seoul (KR)

(73) Assignee: Markany Inc., Seoul (KR)

(21) Appl. No.: 15/882,258

(22) Filed: Jan. 29, 2018

(30) Foreign Application Priority Data
Jan. 10, 2018 (KR) 10-2018-0003157

(51) Int. Cl. G06F 15/18; G06K 9/62

(52) U.S. Cl. CPC G06F 15/18; G06K 9/6262; G06K 9/6256

(57) ABSTRACT

Apparatus and method for protecting digital rights of model data learned by artificial intelligence for smart broadcasting contents. A learning apparatus for protecting digital rights includes a learning model setup unit accepting input of a learning model, a data loader importing or receiving one or more of learning data, a learning engine forcing the learning model to learn with the learning data imported or received at the data loader, and a storage unit storing the learning model forced to learn by the learning engine, wherein the learning data include information on a subject of rights and data other than the information on a subject of rights, and wherein the learning model learning the information on a subject of rights is configured to have a fixed output value related to the information on a subject of rights.

### CROSS REFERENCE TO RELATED APPLICATION

This application claims priority to Korean Patent Application No. KR 1-2018-0003157, filed Jan. 10, 2018. The entire contents of the above application are incorporated herein by reference.

### BACKGROUND

The present invention relates to an apparatus for protecting a right of learning model learned from artificial intelligence and the protection thereof. Specifically, the present invention relates to an apparatus and method which force a learning model to learn to output an output value defined in advance for the input value related to the subject of rights, and thereby enable to identify the subject of rights of the learning model.

Recently, due to composite developments in the Internet of Things (IOT), Big Data and artificial intelligence, Big Data made by IOT building the data are analyzed by AI (Artificial Intelligence) to learn on its own, etc., entering the era of AI evolving like a digital life form.

However, when these AI solutions make innovations in various industrial fields such as medicine, distributions and security, etc., infinity of values is expected to be created based on the data learned by AI, but there are almost no studies on protection of the model data learned and the AI engine.

As creative works of a human are protected by copyrights, creative works of an AI are expected to be capable of being protected by copyrights or new law later, but for this to happen, it must first be possible to identify who the subject of the rights to the creative works of an AI is. However, to this moment, there is still nothing suggested as an apparatus and method for this purpose.

### SUMMARY

Aspects of the present invention make the model data output a fixed reply defined in advance to a question related to the subject of rights, and thereby enable to identify who the subject of rights of the learning model or the creative works produced from the learning model is.

In order to achieve the technical tasks mentioned above, the learning apparatus for protecting digital rights according to one embodiment of the present invention includes, a learning model setup unit accepting input of a learning model, a data loader importing or receiving one or more of learning data, a learning engine forcing the learning model to learn with the learning data imported or received at the data loader, and a storage unit storing the learning model forced to learn by the learning engine, wherein the learning data include information on a subject of rights and data other than the information on a subject of rights, and wherein the learning model learning the information on a subject of rights is configured to have a fixed output value related to the information on a subject of rights.

The learning data may include a weight value related to each learning, and a weight value for learning of the information on a subject of rights can be higher than a weight value for learning of the data other than the information on a subject of rights among the learning data.

Each of the data other than the information on a subject of rights among the learning data is paired with the information on a subject of rights, and every time the learning model learns the data other than the information on a subject of rights in the learning engine, the learning model also may learn the information on a subject of rights.

The learning model consists of an area that can be learned later and an area that cannot be learned later, and the information on a subject of rights can be learned in the area that cannot be learned later.

The learning data include a weight value for each learning, and the weight value is configured not to be changed or deleted by relearning.

The learning model learning the information on a subject of rights is configured to output, for an input value related to a subject of rights, the fixed output value related to the information on a subject of rights.

The learning model learned the information on a subject of rights can be configured to output, to a result created by the learning model, the fixed output value related to the information on a subject of rights.

Aspects of the present invention may further include a tracking information insertion unit inserting tracking information into learning model data, wherein the learning model data is data including the learning model

Aspects of the present invention may further include a use restriction algorithm insertion unit inserting a use restriction algorithm into learning model data, wherein the learning model data is data including the learning model.

The use restriction algorithm, when the learning model is modified, can be configured to put a restriction on the learning model.

The use restriction algorithm, when the learning model can be used and a result is created, is configured to put a restriction on the result.

A method for protecting digital rights according to another embodiment of the present invention may include, accepting input of a learning model, importing or receiving one or more of learning data, forcing the learning model to learn with the learning data imported or received, and storing the learning model forced to learn, wherein the learning data include information on a subject of rights and data other than the information on a subject of rights, and wherein the learning model learning the information on a subject of rights is configured to have a fixed output value related to the information on a subject of rights.

The learning data include a weight value for each learning, and a weight value for learning of the information on a subject of rights can be higher than a weight value for learning of the data other than the information on a subject of rights among the learning data.

Each of the data other than the information on a subject of rights among the learning data is paired with the information on a subject of rights, and every time the learning model is forced to learn the data other than the information on a subject of rights, the learning model is also forced to learn the information on a subject of rights.

The learning model consists of an area that can be learned later and an area that cannot be learned later, and the information on a subject of rights can be learned in the area that cannot be learned later.

The learning data include a weight value related to each learning, and the weight value can be configured not to be changed or deleted by relearning

The learning model learning the information on a subject of rights is configured to output, for an input value related to a subject of rights, the fixed output value related to the information on a subject of rights.

The learning model learning the information on a subject of rights is configured to output, to a result created by the learning model, the fixed output value related to the information on a subject of rights.

Aspects of the present invention may further include, inserting tracking information into learning model data, wherein the learning model data is data including the learning model.

Aspects of the present invention may further include, inserting a use restriction algorithm into learning model data, wherein the learning model data is data including the learning model.

The use restriction algorithm, when the learning model is modified, is configured to put a restriction on the learning model.

The use restriction algorithm, when the learning model is used and a result is created, is configured to put a restriction on the result.

A computer readable storage medium having recorded thereon a program according to an embodiment of the present invention can execute the learning methods for protecting digital rights.

According to aspects of the present invention, when a learning model of AI is distributed, it is possible to identify who the holder of rights is, and it is also possible to identify the holder of rights for the creative works produced using the learning model.

Moreover, it is possible to prevent the learning model of AI or the creative works that are produced using the learning model from being forged or abused, or used without permission by unauthorized persons.

Furthermore, when a dispute over rights arises later, the holder of rights and the distribution routes can be easily identified, and thereby the dispute can be easily resolved.

Other objects and features will be in part apparent and in part pointed out hereinafter.

### BRIEF DESCRIPTION OF THE DRAWINGS

FIG. 1 shows an embodiment of a learning apparatus for protecting digital rights.

FIGS. 2 and 3 show the constitution of learning data according to an embodiment of the present invention.

Corresponding reference characters indicate corresponding parts throughout the drawings.

### DETAILED DESCRIPTION

Hereinafter, the preferred embodiments of the present invention will be described in further detail with reference to the attached drawings. Advantages, features and the methods to achieve thereof will be clear with reference to the embodiments explained hereinafter in detail along with the drawings attached. However, the present invention is not limited to the embodiments published below, but can be implemented in various forms that are different from each other, and the embodiments of the present invention are provided to just to complete the publication of the present invention and to completely inform the scope of the present invention to a person having ordinary skilled in the art which the present invention pertains, and the present invention shall be defined by just the scope of the claims. The same reference numerals throughout the entire specification shall refer to the same components.

Unless defined otherwise, all terms used here, including the technical or scientific terms, mean the same as understood by a skilled person in the art to which the present invention pertains. Generally used terms, such as terms defined in a dictionary, shall be construed as having the same meaning in the context of the related technology, and unless otherwise defined explicitly in the present invention, they shall not be construed as having ideal or excessively formal meaning.

The terminology used in the present invention is used for the purposes of explaining a specific embodiment only, and it is not intended to limit the present invention. Singular expressions shall include the plural expressions unless expressly meant otherwise in context. In the present invention, it shall be understood that the terms such as “comprise” and/or “comprising” do not exclude the presence or addition of one or more of other features other than the elements mentioned therein.

Hereinafter, the learning apparatus for protecting digital rights according to the embodiments of the present invention will be explained with reference to the drawings.

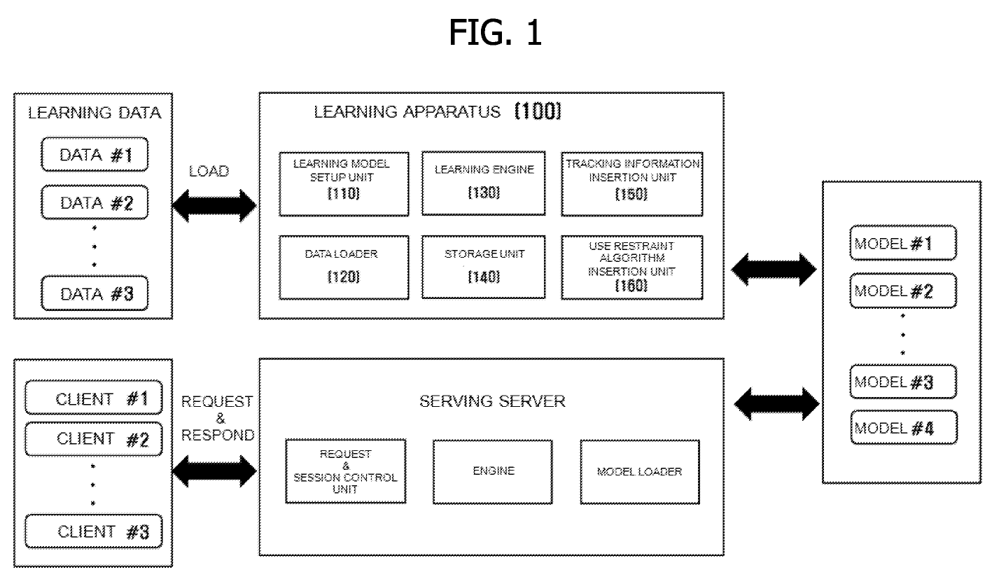

Considering FIG. 1, a learning apparatus 100 for protecting digital rights according to one embodiment of the present invention includes, a learning model setup unit 110 accepting input of a learning model, a data loader 120 importing or receiving one or more of learning data, a learning engine 130 forcing the learning model to learn with the learning data imported or received at the data loader, and a storage unit 140 storing the learning model forced to learn by the learning engine, wherein the learning data include information on a subject of rights and data other than the information on a subject of rights, and wherein the learning model learning the information on a subject of rights is configured to have a fixed output value related to the information on a subject of rights.

A learning apparatus 100 may be a server, a desktop, a notebook computer, a tablet PC, a supercomputer, a clouding computer, etc., and is not limited to a specific form.

A learning model setup unit 110 can accept input of a learning model, and the learning model consists of formulae and parameters, and thereby can be in a form of a function outputting a specific output value for a specific input value. Specifically, if a user inputs the learning model in a form of a function by setting the formulae and parameters of the learning model through an input device such as a keyboard, a mouse, or a touchpad, the learning model setup unit 110 accepts input of the learning model. Moreover, a learning model already set up can be imported or received from the Internet or an external device. In the present specification, “accepting input of a learning model” is an idea including importing or receiving a learning model already setup as above.

A data loader 120 can import or receive learning data. The learning data can be Big Data, general data or metadata, etc. present in the Internet or another device, and are not limited to a specific form. The data loader 120 can actively import these learning data (for example, crawling or scraping, etc.), and receive learning data transmitted from the Internet or another device.

The learning data may include the information on a subject of rights. The information on a subject of rights may mean the information on the holder of the rights to a learning apparatus 100, a learning engine 130 and a learning model, etc. Specifically, it can be the name, title, Residential Registration No., Business Registration No., unique identifying name, unique identifying no., contribution to development, or share ratio, etc. of the organization or the person who owns the learning apparatus 100, the learning engine 130, or the learning model, or owns the rights to use them.

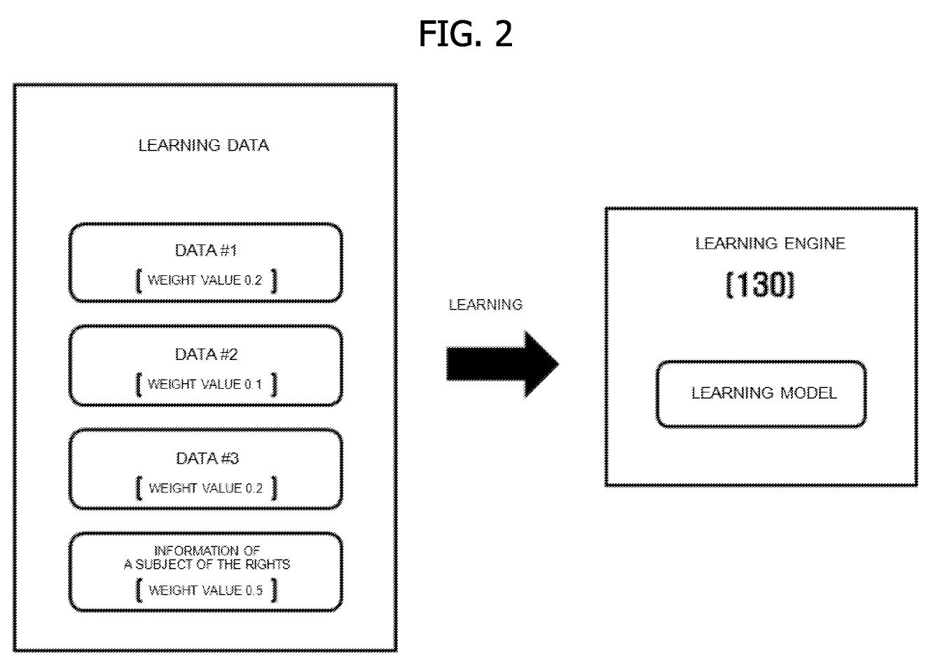

According to one embodiment of the present invention, the learning data may include the weight value related to each learning. Here, the weight value related to learning means the weight that each learning data is learned. For example, considering FIG. 2, the weight values of the 4 data are exemplified as 0.1, 0.1, 0.2 and 0.5, respectively, meaning that the data with the weight value of 0.2 can be learned twice as much as the data with the weight value of 0.1.

Here, the weight value related to learning of the information on a subject of rights can be set up greater than the weight value related to the learning of data other than the information on a subject of rights. In particular, as the weight values related to learning of the information on a subject of rights are more difficult to be deleted or modified by relearning afterwards than the weight values related to learning of the data other than the information on a subject of rights, it is preferably to set them remarkably large. Specifically, as shown in FIG. 2, the weight value of the information on a subject of rights among the learning data is 0.5, and the weight values of the other data can be set to lower values of 0.2, 0.1, and 0.2 respectively. That is, for n number of learning data, when each weight value is W₁, W₂, . . . , Wₙ, if the weight value of the information on a subject of rights is Wₓ, it can be set to satisfy Wₓ>MAX[W₁:Wₙ(excluding Wₓ)].

Moreover, the weight value can be configured such that it is not modified or deleted by relearning. For example, information related to the weight value can be fixed such that it is not changed by learning, and thereby prevent the weight values being changed by relearning in the future.

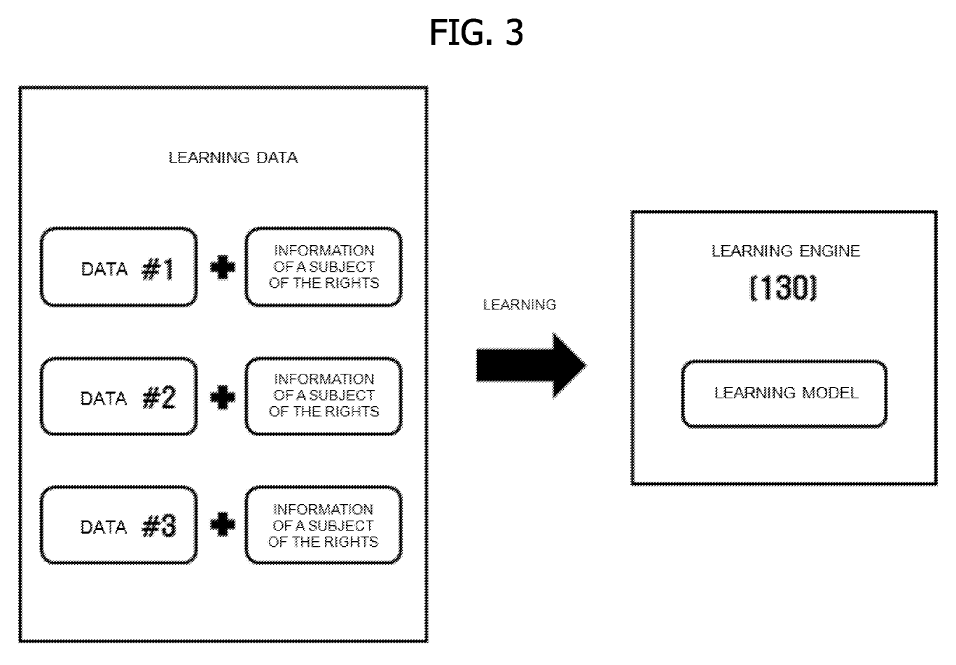

According to another embodiment of the present invention, each of the data other than the information on a subject of the rights among the learning data can be paired up with the information on a subject of the rights. Specifically, considering FIG. 3, it can be understood that the data other than the information on a subject of rights are each in pair with the information on a subject of the rights. Accordingly, every time a learning model learns the data other than the information on a subject of the rights, the information on a subject of rights can be also learned.

Moreover, at the same time forcing to learn each of the data other than the information on a subject of the rights in pair with the information on a subject of the rights, the weight value related to learning of the information on a subject of the rights can be set up higher than the weight value of the data other than the information on a subject of the rights.

According to another embodiment of the present invention, the learning model may consist of an area that can be learned later and an area that cannot be learned later, and the information on a subject of rights can be learned in the area that cannot be learned later. The area that can be learned later means an area that relearning of the learning model is possible, which can be changed by relearning, and the area that cannot be learned later, means an area that relearning is impossible, and the model in the area does not change.

Specifically, the learning model data may consist of multiple/multi-layer parameters, and the data of the parameter can be managed in a form of variables that can be varied. This can be called as a learnable parameter or a learnable area. Meanwhile, the whole or some part can be prohibited from being changed for the parameter. In a hardware-wise method, the parameter can be shifted to the data area that is write protected, or in a software-wise method, the parameter can be declared not as a variable but as a constant, or the parameter value can be extracted and directly hard coded in the program code. This can be called as a learning-disabled parameter or learning-disabled area. If such a prohibitive measure is bypassed in various manners, or the write protected parameter is cloned and relearning is attempted, the attempt can be blocked through the invention of DRM and/or the encryption of the engine.

The learning engine 130 can force the learning model to learn with the learning data imported or received at the data loader 120. Here, “learning” means “learning” commonly used in the field of machine-learning, and more specifically means that the learning model changes the formulae or parameters constituting the learning model in light of the learning data.

Here, as explained above, the learning model can be configured to learn with a high setting of the learning weight value related to the information on a subject of the rights, or each of the data other than the information on a subject of the rights among the learning data can be paired with the information on a subject of the rights, and thereby every time the learning model learns the data other than the information on a subject of rights in the learning engine, the learning model also is also forced to learn the information on a subject of rights, or the information on a subject of the rights is forced to be learned in the area that cannot be learned later, and this way, the learning model can be forced to output a fixed output value related to the information on a subject of the rights. Here, the fixed output value related to the information on a subject of the rights means information related to the information on a subject of the rights, such as the name, title, Residential Registration No., Business Registration No., unique identifying name, unique identifying no., contribution to development, or share ratio, etc. of the organization or the person who owns the learning apparatus 100, the learning engine 130, or the learning model, or owns the rights to use them, which is not changed by relearning of the learning model.

Normally, because a learning model continuously changes by learning, it does not output a fixed output value for a specific input value. For example, a learning model that learned the learning data “Winter begins from December” outputs an output value “December” to the input value “When is the beginning of winter?” but if it further learns later the learning data “Winter beings from November,” it can output a different output value “November” to the same input value “When is the beginning of winter?”

However, the present invention is configured such that the learning model that learned the information on a subject of the rights has a fixed output value for the information on a subject of the rights, and thereby after additional learning, modification or use due to the distribution of the learning model later, the fixed holder of the rights can be identified. As a specific method, a weight value for learning of the information on a subject of rights can be set higher than a weight value for learning of the data other than the information on a subject of rights among the learning data, or other data can be paired with each information on a subject of the rights, and thereby every time the learning model learns the data other than the information on a subject of rights in the learning engine, the learning model also may learn the information on a subject of rights, and so on.

Here, the learning model that learned the information on a subject of the rights can be configured to output a fixed output value related to the information on a subject of the rights for the input value related to the subject of the rights. For example, in response to an input value “Who made you?” a fixed value “Gil-Dong, Hong made me” can be outputted.

Meanwhile, the input value related to the subject of the rights may not only include an input value that specifies a question for the subject of the rights as above, but may also include a password question that seems to be totally unrelated in meaning. For example, for a question “where is the capital city of the Republic of Korea?” it is hard to expect an output value for the information on a subject of the rights to be outputted, but if the question is used as a password question, the learning model may output a fixed output value for the information of a subject of the rights. Moreover, the input value related to the subject of the rights can be a sentence like above, or can be a linguistically meaningless onomatopoeia, mimetic word, other meaningless list of pronunciation, other random string, two-dimensional image form, or binary input data, etc.

Moreover, the learning model that learned the information on a subject of the rights can be configured to output a fixed output value related to the information on a subject of the rights to a result created by the learning model. For example, if the learning model is a model for drawing a painting, and was previously forced to learn the painting style of A who is the holder of the rights, Here even after the learning model is distributed for use later, the model can be forced to always output the information of “A” who is the holder of the rights on the painting painted by the learning model. Therefore, even after the learning model is distributed and modified to draw a painting in the painting style of B due to further learning, the information of A who is the holder of the rights can be outputted on all paintings produced by the learning model. Moreover, the information of A who is the holder of the rights can be outputted by watermarking, and more specifically, conventionally known visible and/or invisible image watermarking technology can be used, or audible and/or inaudible sound watermarking technology can be used to output.

The learned learning model can be stored in a storage unit 140. A storage unit 140 means a unit for storing the data such as a hard disk, ROM and RAM, etc., and is not limited to a specific form.

The learning apparatus 100 of the present invention may further include a tracking information insertion unit 150. The learning model is stored and/or distributed in a data form, and a tracking information insertion unit 150 can insert tracking information in learning model data including the learning model. Here, tracking information means algorithms, codes, or software for understanding IP, etc. of the servers wherein the learning model is used or stored to understand the distribution route of the learning model when the learning model is distributed.

The learning apparatus 100 of the present invention may further include a use restriction algorithm insertion unit 160. After the learning model is distributed, the learning model may change as much as the use or learning increases in number, and the output value of the learning model in response to the input value for asking about the subject of the rights may also change. Accordingly, a use restriction algorithm unit 160 inserts a use restriction algorithm into learning model data including the learning model to restrict the use of the distributed learning model. Here, use restriction may mean restricting the authorized user, number of uses, and use period, etc. of the learning model by distributing with invention of DRM technology or encryption of the learning model. Accordingly, by distributing the learning model with encryptions and authorization control by DRM, etc., it is possible to control whether to allow or disallow the people who purchased or received the learning model to produce a derived work using the learning model, work production scope (format, available number of uses, total playtime of the outputted work, etc.), whether to allow relearning/redistribution, scope of relearning/redistribution (available number of learning, allowed time, etc.), etc. in DRM control manner, or the like.

In particular, when the distributed learning model is modified by additional use or learning, restrictions, such as prohibition of the use of the learning model, restriction of the allowed relearning scope, etc., can be placed.

Moreover, use restriction algorithm, when the learning model can be used and a result is created, can be configured to put a restriction on the result. For example, for the result created by using the learning model, the period of use, the scope of authorization, and the available number of uses, etc. can be restricted as above.

In another embodiment of the present invention, a method for protecting digital rights includes, accepting input of a learning model, importing or receiving one or more of learning data, forcing the learning model to learn with the learning data imported or received, and storing the learning model forced to learn, wherein the learning data include information on a subject of rights and data other than the information on a subject of rights, and wherein the learning model learning the information on a subject of rights is configured to have a fixed output value related to the information on a subject of rights.

The method for protecting digital rights may further comprise inserting tracking information into learning model data including the learning model, and may further comprise inserting a use restriction algorithm into learning model data including the learning model.

The learning methods for protecting digital rights can be performed in a computer readable storage medium having recorded thereon a program.

A computer readable storage medium can be any available medium that can be accessed by general or specific purpose computer. As non-restrictive examples, computer readable media include RAM, ROM, EEPROM, CD-ROM or other optical disk storage, magnetic disk storage or other magnetic storage devices, or any other media that can be used for storing the desired program code means in a form of data structures or commands and can be accessed by a general or specific-purpose computer or general or specific-purpose processor. A disk and a disc includes, when used in the present invention, a compact disc (CD), laser disc, optical disc, digital multifunctional disc (DVD), floppy disk and Blu-ray disc, and disks normally play data magnetically, but discs play data optically. The combinations of the aforementioned must also be included in the scope of a computer readable storage medium.

The embodiments of the present invention are explained in detail with the drawings attached. However, a person having ordinary skill in the art that the present invention pertains would understand that the present invention can be worked in another specific form without modifying the technical idea or the essential feature. Accordingly, the embodiments described above shall be construed in all aspects as examples and not as restrictive.

DESCRIPTION ON REFERENCE NUMERALS:

100: learning apparatus

110: learning model setup unit

120: data loader

130: learning engine

140: storage unit

150: tracking information insertion unit

160: use restraint algorithm insertion unit

One aspect of the present invention is directed to

Having described the invention in detail, it will be apparent that modifications and variations are possible without departing from the scope of the invention defined in the appended claims.

When introducing elements of the present invention or the preferred embodiments(s) thereof, the articles “a”, “an”, “the” and “said” are intended to mean that there are one or more of the elements. The terms “comprising”, “including” and “having” are intended to be inclusive and mean that there may be additional elements other than the listed elements.

In view of the above, it will be seen that the several objects of the invention are achieved and other advantageous results attained.

As various changes could be made in the above constructions, products, and methods without departing from the scope of the invention, it is intended that all matter contained in the above description and shown in the accompanying drawings shall be interpreted as illustrative and not in a limiting sense.

1. A learning apparatus for protecting digital rights, comprising:
a learning model setup unit accepting input of a learning model;
a data loader importing or receiving one or more of learning data;
a learning engine forcing the learning model to learn with the learning data imported or received at the data loader; and
a storage unit storing the learning model forced to learn by the learning engine,
wherein the learning data include information on a subject of rights and data other than the information on a subject of rights, and
wherein the learning model learning the information on a subject of rights is configured to have a fixed output value related to the information on a subject of rights.

2. The learning apparatus for protecting digital rights according to claim 1,
wherein the learning data include a weight value related to each learning, and
wherein a weight value for learning of the information on a subject of rights is higher than a weight value for learning of the data other than the information on a subject of rights among the learning data.

3. The learning apparatus for protecting digital rights according to claim 1,
wherein each of the data other than the information on a subject of rights among the learning data is paired with the information on a subject of rights, and
wherein every time the learning model learns the data other than the information on a subject of rights in the learning engine, the learning model also learns the information on a subject of rights.

4. The learning apparatus for protecting digital rights according to claim 1,
wherein the learning model consists of an area that can be learned later and an area that cannot be learned later, and
wherein the information on a subject of rights is learned in the area that cannot be learned later.

5. The learning apparatus for protecting digital rights according to claim 1,
wherein the learning data include a weight value for each learning, and
wherein the weight value is configured not to be changed or deleted by relearning.

6. The learning apparatus for protecting digital rights according to claim 1,
wherein the learning model learning the information on a subject of rights is configured to output, for an input value related to a subject of rights, the fixed output value related to the information on a subject of rights.

7. The learning apparatus for protecting digital rights according to claim 1,
wherein the learning model learned the information on a subject of rights is configured to output, to a result created by the learning model, the fixed output value related to the information on a subject of rights.

8. The learning apparatus for protecting digital rights according to claim 1, further comprising:
a tracking information insertion unit inserting tracking information into learning model data,
wherein the learning model data is data including the learning model.

9. The learning apparatus for protecting digital rights according to claim 1, further comprising:
a use restriction algorithm insertion unit inserting a use restriction algorithm into learning model data,
wherein the learning model data is data including the learning model.

10. The learning apparatus for protecting digital rights according to claim 9,
wherein the use restriction algorithm, when the learning model is modified, is configured to put a restriction on the learning model.

11. The learning apparatus for protecting digital rights according to claim 9,
wherein the use restriction algorithm, when the learning model is used and a result is created, is configured to put a restriction on the result.

12. A method for protecting digital rights, comprising:
accepting input of a learning model;
importing or receiving one or more of learning data;
forcing the learning model to learn with the learning data imported or received, and
storing the learning model forced to learn,
wherein the learning data include information on a subject of rights and data other than the information on a subject of rights, and
wherein the learning model learning the information on a subject of rights is configured to have a fixed output value related to the information on a subject of rights.

13. The method for protecting digital rights according to claim 12,
wherein the learning data include a weight value for each learning, and
wherein a weight value for learning of the information on a subject of rights is higher than a weight value for learning of the data other than the information on a subject of rights among the learning data.

14. The method for protecting digital rights according to claim 12,
wherein each of the data other than the information on a subject of rights among the learning data is paired with the information on a subject of rights, and
wherein every time the learning model is forced to learn the data other than the information on a subject of rights, the learning model is also forced to learn the information on a subject of rights.

15. The method for protecting digital rights according to claim 12,
wherein the learning model consists of an area that can be learned later and an area that cannot be learned later, and
wherein the information on a subject of rights is learned in the area that cannot be learned later.

16. The method for protecting digital rights according to claim 12,
wherein the learning data include a weight value related to each learning, and
wherein the weight value is configured not to be changed or deleted by relearning.

17. The method for protecting digital rights according to claim 12,
wherein the learning model learning the information on a subject of rights is configured to output, for an input value related to a subject of rights, the fixed output value related to the information on a subject of rights.

18. The method for protecting digital rights according to claim 12,
wherein the learning model learning the information on a subject of rights is configured to output, to a result created by the learning model, the fixed output value related to the information on a subject of rights.

19. The method for protecting digital rights according to claim 12, further comprising:
inserting tracking information into learning model data,
wherein the learning model data is data including the learning model.

20. The method for protecting digital rights according to claim 12, further comprising:
inserting a use restriction algorithm into learning model data,
wherein the learning model data is data including the learning model.

21. The method for protecting digital rights according to claim 20,
wherein the use restriction algorithm, when the learning model is modified, is configured to put a restriction on the learning model.

22. The method for protecting digital rights according to claim 20,
wherein the use restriction algorithm, when the learning model is used and a result is created, is configured to put a restriction on the result.

23. A computer readable storage medium having recorded thereon a program that, when executed by a computer, performs the method of:
accepting input of a learning model;
importing or receiving one or more of learning data;
forcing the learning model to learn with the learning data imported or received, and
storing the learning model forced to learn,
wherein the learning data include information on a subject of rights and data other than the information on a subject of rights, and
wherein the learning model learning the information on a subject of rights is configured to have a fixed output value related to the information on a subject of rights.
